(19) United States
(12) Patent Application Publication
(10) Pub. No.: US 2019/0184686 A1
(43) Pub. Date: Jun. 20, 2019

(54) ARTICLES OF CONTROLLABLY BONDED SHEETS AND METHODS FOR MAKING SAME

(71) Applicant: CORNING INCORPORATED, CORNING, NY (US)

(72) Inventors: Robert Alan Bellman, Ithaca, NY (US); Jiangwei Feng, Painted Post, NY (US); Prantik Mazumder, Ithaca, NY (US)

(21) Appl. No.: 16/326,273

(22) PCT Filed: Aug. 15, 2017
(86) PCT No.: PCT/US2017/046836

§ 371 Date: Feb. 18, 2019

Related U.S. Application Data
(60) Provisional application No. 62/377,927, filed on Aug. 22, 2016.

(51) Int. Cl. B32B 17/10; B32B 37/24; B32B 27/28

(52) U.S. Cl. CPC B32B 17/10036; B32B 17/10688; B32B 37/24; B32B 2457/14; B32B 2037/246; B32B 2355/00; B32B 2457/206; B32B 27/286

(57) ABSTRACT

Described herein are articles and methods of making articles, for example glass articles, comprising a thin sheet and a carrier, wherein the thin sheet and carrier are bonded together using a modification (coating) layer, for example an aromatic polymer coating layer, and associated deposition methods and inert gas treatments that may be applied on the thin sheet, the carrier, or both, to control van der Waals, hydrogen and covalent bonding between the thin sheet and the carrier. The modification layer bonds the thin sheet and carrier together with sufficient bond strength to prevent delamination of the thin sheet and the carrier during high temperature processing while preventing a permanent bond during high temperature processing.

### CROSS-REFERENCE TO RELATED APPLICATIONS

This application claims the benefit of priority under 35 U.S.C. § 119 of U.S. Provisional Application Ser. No. 62/377,927 filed on Aug. 22, 2016, the content of which is relied upon and incorporated herein by reference in its entirety.

### FIELD

The present disclosure relates generally to articles including and methods for making thin sheets on carriers and, more particularly, to articles including and methods for making thin glass sheets controllably bonded on glass carriers.

### BACKGROUND

Flexible substrates offer the promise of cheaper devices using roll-to-roll processing, and the potential to make thinner, lighter, more flexible and durable displays. However, the technology, equipment, and processes required for roll-to-roll processing of high quality displays are not yet fully developed. Since panel makers have already heavily invested in toolsets to process large sheets of glass, laminating a flexible substrate to a carrier and making display devices on the flexible substrate by sheet-to-sheet processing offers a shorter term solution to develop the value proposition of thinner, lighter, and more flexible displays. Displays have been demonstrated on polymer sheets, for example polyethylene naphthalate (PEN), where the device fabrication was sheet-to-sheet with the PEN laminated to a glass carrier. The upper temperature limit of the PEN limits the device quality and process that can be used. In addition, the high permeability of the polymer substrate leads to environmental degradation of organic light emitting diode (OLED) devices where a near hermetic package is required. Thin film encapsulation offers a potential solution to overcome this limitation, but it has not yet been demonstrated to offer acceptable yields at large volumes.

In a similar manner, display devices can be manufactured using a glass carrier laminated to one or more thin glass substrates. It is anticipated that the low permeability and improved temperature and chemical resistance of the thin glass will enable higher performance longer lifetime flexible displays.

Some devices utilize amorphous silicon thin film transistors (a-Si TFTs), which are typically fabricated at temperatures around 350° C. However, indium gallium zinc oxide (IGZO or Oxide TFT) and low temperature polysilicon (LTPS) devices are also important. Oxide TFT processing is typically performed at temperatures of 400 to 450° C. In LTPS device fabrication processes, temperatures typically approach 600° C. or greater. In each of these processing techniques, vacuum, and wet etch environments may also be used. These conditions limit the materials that may be used, and place high demands on the carrier and/or thin sheet. Accordingly, what is desired is a carrier approach that utilizes the existing capital infrastructure of the manufacturers, enables processing of glass sheets, e.g., thin glass sheets having a thickness ≤0.3 millimeters (mm) thick, without contamination or loss of bond strength between the thin sheet and carrier at higher processing temperatures, and wherein the thin sheet debonds easily from the carrier at the end of the process.

One commercial advantage is that manufacturers will be able to utilize their existing capital investment in processing equipment while gaining the advantages of the thin sheets, e.g., thin glass sheets, for photovoltaic (PV), OLED, liquid crystal displays (LCDs) and patterned thin film transistor (TFT) electronics, for example. Additionally, such an approach enables process flexibility, including: processes for cleaning and surface preparation of the thin sheet and carrier to facilitate bonding.

### SUMMARY

In light of the above, there is a need for a thin sheet—carrier article that can withstand the rigors of TFT and flat panel display (FPD) processing, including high temperature processing (without outgassing which would be incompatible with the semiconductor or display making processes in which it will be used), yet allow the entire area of the thin sheet to be removed (either all at once, or in sections) from the carrier so as to allow the reuse of the carrier for processing another thin sheet. The present specification describes methods to control the adhesion between the carrier and thin sheet to create a temporary bond sufficiently strong to survive TFT and FPD processing (including processing at temperatures of about 300° C., about 400° C., and up to less than 500° C.), but weak enough to permit debonding of the sheet from the carrier, even after high-temperature processing. Such controlled bonding can be utilized to create an article having a re-usable carrier, or alternately an article having patterned areas of controlled bonding and covalent bonding between a carrier and a sheet. More specifically, the present disclosure provides surface modification layers (including various materials and associated surface heat treatments), that may be provided on the thin sheet, the carrier, or both, to control both room-temperature van der Waals, and/or hydrogen, bonding and high temperature covalent bonding between the thin sheet and carrier. Even more specifically, the present disclosure describes methods of depositing a coating layer that serves to bond a thin sheet to a carrier, methods for preparing the coating layer for bonding, and bonding the coating layer to both the thin sheet and the carrier. These methods produce bonding between the components such that the bonding energy is not too high, which might render the components inseparable after electronic device processing, and such that the bonding energy is not too low, which might lead to compromised bonding quality thus leading to possible debonding or fluid ingress between the thin sheet and carrier during electronic device processing. These methods also produce an article that exhibits low outgassing and survives high temperature processing, for example amorphous silicon (a-Si) TFT processing, as well as additional processing steps, for example wet cleaning and dry etching. In alternative embodiments, the coating layers may be used to create various controlled bonding areas (wherein the carrier and thin sheet remain sufficiently bonded through various processes, including vacuum processing, wet processing, and/or ultrasonic cleaning processing), together with covalent bonding regions to provide for further processing options, for example, maintaining hermeticity between the carrier and sheet even after dicing the article into smaller pieces for additional device processing.

In a first aspect, there is an article comprising: a first sheet having a first sheet bonding surface, a second sheet having a second sheet bonding surface and a modification layer having a modification layer bonding surface, the modification layer coupling the first sheet and the second sheet. The modification layer comprises one or more plasma-polymerized aromatic compounds formed by the deposition of a monomer of the following structure:

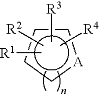

wherein A=C, S or N
n=1 or 2
R¹, R², R³, R⁴ are each independently selected from H, C₁-C₅ alkyl, vinyl, allyl, amino, glycidyl and thiol.

In a second aspect, there is an article comprising a first sheet having a first sheet bonding surface; a second sheet having a second sheet bonding surface and a modification layer having a modification layer bonding surface, the modification layer coupling the first sheet and the second sheet. The modification layer comprises one or more polymerized monomers of the following structure:

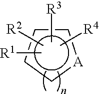

wherein A=C, S or N
n=1 or 2

R¹, R², R³, R⁴ are each independently selected from H, C₁-C₅ alkyl, vinyl, allyl, amino, glycidyl and thiol.

In an example of the preceding aspects, the modification layer is bonded with the second sheet bonding surface.

In another example of the preceding aspects, the modification layer bonding surface is bonded with the first sheet bonding surface.

In a third aspect, there is provided an article of any of the preceding aspects, the monomer being a compound of the formula:

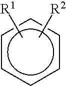

wherein R¹, R² are each independently selected from H, C₁-C₅ alkyl, vinyl, allyl, amino, glycidyl and thiol.

In an example of aspect 3, the monomer is p-xylene.

In a fourth aspect, there is provided an article of any one or both of the first or second aspects, wherein the monomer is a compound of the formula:

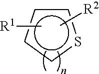

wherein R¹, R² are each independently selected from H, C₁-C₅
alkyl, vinyl, allyl, amino, glycidyl and thiol.

In an example of aspect 4, the monomer is an alkyl thiophene.

In an example of aspect 4, the monomer is methyl thiophene.

In another example of aspect 4, the monomer is dimethyl thiophene

In another example of either one or both of the first and second aspects, the modification layer bonding surface can be bonded with the second sheet bonding surface with a bond energy of less than about 325 mJ/m² after holding the glass article at about 300° C. for about 10 minutes in a nitrogen atmosphere.

In yet another example of either one or both of the first and second aspects, the modification layer bonding surface can be bonded with the second sheet bonding surface with a bond energy of less than about 200 mJ/m² after holding the glass article at about 400° C. for about 10 minutes in a nitrogen atmosphere.

In another example of either one or both of the first and second aspects, the modification layer can have an average thickness of less than about 200 nm (nanometers).

In another example of either one or both of the first and second aspects, the modification layer can have an average thickness of less than about 100 nm.

In another example of either one or both of the first and second aspects, the modification layer can have an average thickness of about 3 to about 50 nm.

In another example of either one or both of the first and second aspects, the modification layer can have an average thickness of about 20 to about 35 nm.

In another example of either one or both of the first and second aspects, the change in percent blister area of the modification bonding layer is less than 10 percent after holding the glass article at about 300° C. for about 10 minutes in a nitrogen atmosphere.

In another example of aspect 3, the change in percent blister area of the modification bonding layer is less than 5 percent after holding the glass article at about 300° C. or about 400° C. for about 10 minutes in a nitrogen atmosphere.

In another example of either one or both of the first and second aspects, the second sheet has an average thickness of about 300 microns or less.

In another example of either one or both of the first and second aspects, the first sheet has an average thickness of about 200 microns or more.

In another example of either one or both of the first and second aspects, the second sheet has an average thickness less than that of the first sheet.

In another example of either one or both of the first and second aspects, the first and or second sheets comprise glass, ceramic, glass-ceramic, silicon, metal or layers of the foregoing.

The first and second aspects may be provided alone or in combination with any one or more of the examples of the first, second, third or fourth aspects discussed above.

In a fifth aspect, there is a method of making an article comprising: forming a modification layer on a bonding surface of a first sheet by depositing via plasma polymerization at least one monomer of the following formula:

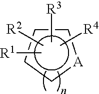

wherein A=C, S or N
n=1 or 2
R¹, R², R³, R⁴ are each independently selected from H, C₁-C₅ alkyl, vinyl, allyl, amino, glycidyl and thiol
   to form the modification layer, the modification layer comprising a modification layer bonding surface, and bonding the modification layer bonding surface to a bonding surface of a second sheet.

In a sixth aspect, there is a method of making an article comprising: forming a modification layer on one or more of a bonding surface of a first sheet or a bonding surface of a second sheet by depositing via chemical vapor deposition at least one monomer of the following formula:

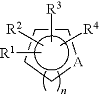

wherein A=C, S or N
n=1 or 2
R¹, R², R³, R⁴ are each independently selected from H, C₁-C₅ alkyl, vinyl, allyl, amino, glycidyl and thiol to form the modification layer, the modification layer comprising a modification layer bonding surface, and coupling the first sheet and the second sheet with the modification layer.

In an example of either one or both of fifth or sixth aspects, the monomer can be selected from the group consisting of p-xylene, methyl thiophene and dimethyl thiophene.

In another example of the sixth aspect, the monomer can be deposited on the first or second sheet bonding surfaces using plasma polymerization

In another example of either one or both of fifth or sixth aspects, the monomer is deposited at a temperature of about 25 to 250° C.

In another example of either one or both of fifth or sixth aspects, the monomer deposited on the first sheet is held at about 180° C. for about 10 minutes in a nitrogen atmosphere prior to bonding the modification layer to the bonding surface of the second sheet.

In another example of either one or both of fifth or sixth aspects, the method further includes the step of increasing the surface energy of the modification layer bonding surface prior to bonding the modification layer bonding surface to the bonding surface of the second sheet.

In another example of either one or both of fifth or sixth aspects, the surface energy of the modification layer bonding surface is increased prior to bonding the modification layer to the bonding surface of the second sheet.

In another example of either one or both of fifth or sixth aspects, the surface energy of the modification layer bonding surface is increased by exposing the modification layer bonding surface to nitrogen, oxygen, hydrogen, carbon dioxide gas or a combination thereof.

In another example of either one or both of fifth or sixth aspects, the surface energy of the modification layer bonding surface is increased to between about 55 and about 75 mJ/m².

In yet another example of either one or both of fifth or sixth aspects, the surface energy of the modification layer bonding surface is increased to between about 60 and about 70 mJ/m².

In another example of either one or both of fifth or sixth aspects, the modification layer has an average thickness of less than about 200 nm.

In another example of either one or both of fifth or sixth aspects, the modification layer has an average thickness of less than about 100 nm.

In another example of either one or both of fifth or sixth aspects, the modification layer has an average thickness of about 3 to about 50 nm.

In another example of either one or both of fifth or sixth aspects, the modification layer has an average thickness of about 20 to about 35 nm.

In another example of either one or both of fifth or sixth aspects, the modification layer bonding surface is bonded with the second sheet bonding surface with a bond energy of less than about 325 mJ/m² after holding the glass article at about 300° C. for about 10 minutes in a nitrogen atmosphere.

In yet another example of either one or both of fifth or sixth aspects, the modification layer bonding surface is bonded with the second sheet bonding surface with a bond energy of less than about 200 mJ/m² after holding the glass article at about 400° C. for about 10 minutes in a nitrogen atmosphere.

In another example of either one or both of fifth or sixth aspects, the second sheet has an average thickness less than that of the first sheet.

In another example of either one or both of fifth or sixth aspects, the second sheet has an average thickness of about 300 microns or less.

In another example of either one or both of the fifth or sixth aspects, the first sheet has an average thickness of about 200 microns or more.

In another example of either one or both of fifth or sixth aspects, the first sheet and/or second sheet comprise glass, ceramic, glass-ceramic, silicon, metal or layers of the foregoing.

The fifth and sixth aspects may be provided alone or in combination with any one or more of the examples of the fifth or sixth aspects discussed above.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 is a schematic side view of an article having first sheet bonded to a second sheet with a modification layer therebetween, according to some embodiments.

FIG. 2 is an exploded and partially cut-away view of the article in FIG. 1.

FIG. 3 is a graph of bond energy (mJ/m² on the left-hand Y axis) and change in blister area (% on the right-hand Y axis) v. temperature (° C. on the X axis) for a p-xylene modification layer.

FIG. 4 is a graph of bond energy (mJ/m² on the left-hand Y axis) and change in blister area (% on the right-hand Y axis) v. temperature (° C. on the X axis) for a methyl thiophene modification layer.

FIG. 5 is a graph of bond energy (mJ/m² on the left-hand Y axis) and change in blister area (% on the right-hand Y axis) v. temperature (° C. on the X axis) for a dimethyl thiophene modification layer.

### DETAILED DESCRIPTION

Example embodiments will now be described more fully hereinafter with reference to the accompanying drawings in which example embodiments of the claimed invention are shown. Whenever possible, the same reference numerals are used throughout the drawings to refer to the same or like parts. However, the embodiments may take on many different forms and should not be construed as limited to those specifically set forth herein. These example embodiments are provided so that this disclosure will be both thorough and complete, and will fully convey the scope of the claims to those skilled in the art.

Directional terms as used herein (e.g., up, down, right left, front, back, top, bottom) are made only with reference to the figures as drawn and are not intended to imply absolute orientation.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Provided are solutions for allowing the processing of a first sheet coupled to a second sheet, whereby at least portions of the second sheet, for example, a thin glass sheet, remain “non-bonded” so that devices (for example TFTs) may be processed onto the thin sheet, and the thin sheet may be removed from the first sheet, for example, a carrier. In order to maintain advantageous surface shape characteristics, the carrier is typically a display grade glass substrate, such as Corning EAGLE XG® alkali-free display glass. Accordingly, in some situations, it may be wasteful and expensive to merely dispose of the carrier after one use. Thus, in order to reduce costs of display manufacture, it is desirable to be able to reuse the carrier to process more than one thin sheet substrate. The present disclosure sets forth articles and methods for enabling a thin sheet to be processed through the harsh environment of the processing lines, such as TFT, including high temperature processing, wherein high temperature processing is processing at a temperature ≥about 300° C., ≥about 400° C., and up to less than 500° C., and wherein the processing temperature may vary depending upon the type of device being made, for example, temperatures up to about 400° C. or up to about 450° C. as in amorphous silicon or amorphous IGZO backplane processing—and yet still allow the thin sheet to be easily removed from the carrier without damage (for example, wherein one of the carrier and the thin sheet breaks or cracks into two or more pieces) to the thin sheet or carrier, whereby the carrier may be reused. The articles and methods of the present disclosure can be applied to other high-temperature processing, for example, processing at a temperature in the range of 300° C. to 450° C. to less than 500° C., and yet still allow the thin sheet to be removed from the carrier without significantly damaging the thin sheet.

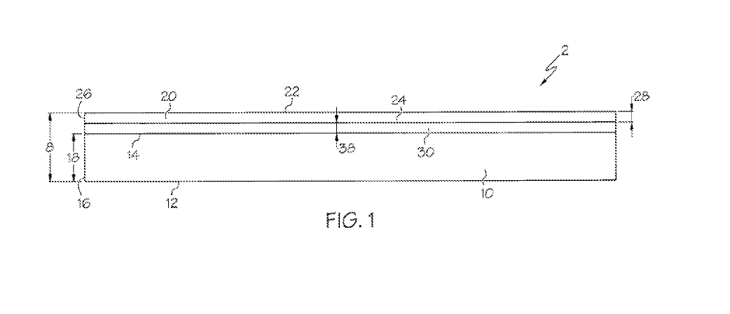

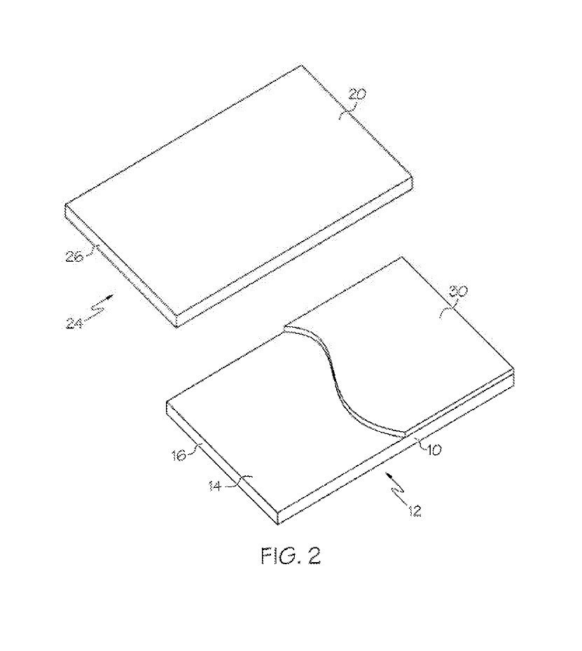

As shown in FIGS. 1 and 2, an article 2, for example a glass article, has a thickness 8, and includes a first sheet 10 (for example a carrier) having a thickness 18, a second sheet 20 (e.g., a thin glass sheet) having a thickness 28, and a modification layer 30 having a thickness 38. Thickness 28 of the thin sheet 20 may be, for example, equal to or less than about 300 micrometers (μm, or microns), including but not limited to thicknesses of, for example, about 10 to about 50 micrometers, about 50 to about 100 micrometers, about 100 to about 150 μm, about 150 to about 300 μm, about 300 μm, about 250 μm, about 200 μm, about 190 μm, about 180 μm, about 170 μm, about 160 μm, about 150 μm, about 140 μm, about 130 μm, about 120 μm, about 110 μm, about 100 μm, about 90 μm, about 80 μm, about 70 μm, about 60 μm, about 50 μm, about 40 μm, about 30 μm, about 20 μm, or about 10 μm.

The article 2 is arranged to allow the processing of thin sheet 20 in equipment designed for thicker sheets, for example, those on the order of greater than or equal to about 0.4 mm, for example about 0.4 mm, about 0.5 mm, about 0.6 mm, about 0.7 mm, about 0.8 mm, about 0.9 mm, or about 1.0 mm, although the thin sheet 20 itself is equal to or less than about 300 μm. The thickness 8 of the article 2, which is the sum of thicknesses 18, 28, and 38, can be equivalent to that of the thicker sheet for which a piece of equipment, for example equipment designed to dispose electronic device components onto substrate sheets, was designed to process. In an example, if the processing equipment was designed for a 700 μm sheet, and the thin sheet had a thickness 28 of about 300 μm, then thickness 18 would be selected as about 400 μm, assuming that thickness 38 is negligible. That is, the modification layer 30 is not shown to scale, but rather it is greatly exaggerated for sake of illustration only. Additionally, in FIG. 2, the modification layer is shown in cut-away. The modification layer can be disposed uniformly over the bonding surface 14 when providing a reusable carrier. Typically, thickness 38 will be on the order of nanometers (nm), for example from about 2 nm to about 1 μm, from about 5 nm to about 250 nm, or from about 20 nm to about 100 nm, or about 30 nm, about 40 nm, about 50 nm, about 60 nm, about 70 nm, about 80 nm or about 90 nm. In another example, thickness 38 can be less than about 200 nm, about 150 nm, about 100 nm, about 75 nm, about 50 nm, about 40 nm, about 35 nm or about 30 nm. The presence of a modification layer may be detected by surface chemistry analysis, for example by time-of-flight secondary ion mass spectrometry (ToF SIMS).

First sheet 10, which may be used as a carrier for example, has a first surface 12, a bonding surface 14, and a perimeter 16. The first sheet 10 may be of any suitable material including glass. The first sheet can be a non-glass material, for example, ceramic, glass-ceramic, silicon, or metal (as the surface energy and/or bonding may be controlled in a manner similar to that described below in connection with a glass carrier). If made of glass, first sheet 10 may be of any suitable composition including alumino-silicate, boro-silicate, alumino-boro-silicate, soda-lime-silicate, and may be either alkali containing or alkali-free depending upon its ultimate application. Further, in some examples, when made of glass, glass-ceramic, or other material, the first sheet bonding surface can be made of a coating or layer of metal material disposed on the underlying bulk material of the first sheet. Thickness 18 may be from about 0.2 to about 3 mm, or greater, for example about 0.2 mm, about 0.3 mm, about 0.4 mm, about 0.5 mm, about 0.6 mm, about 0.65 mm, about 0.7 mm, about 1.0 mm, about 2.0 mm, or about 3.0 mm, or greater, and will depend upon the thickness 28, and thickness 38 when thickness 38 is non-negligible, as noted above. The thickness 18 of the first sheet 10 in some embodiments may be greater than the thickness 28 of the thin sheet 20. In some embodiments, thickness 18 may be less than thickness 28. In one embodiment, the first sheet 10 may be made of one layer, as shown, or multiple layers (including multiple thin sheets) that are bonded together. Further, the first sheet may be of a Gen 1 size or larger, for example, Gen 2, Gen 3, Gen 4, Gen 5, Gen 8 or larger (e.g., sheet sizes from about 100 mm×100 mm to about 3 meters×3 meters or greater).

The thin sheet 20 has a first surface 22, a bonding surface 24, and a perimeter 26. Perimeters 16 (first sheet) and 26 (thin sheet) may be of any suitable shape, may be the same as one another, or may be different from one another. Further, the thin sheet 20 may be of any suitable material including glass, ceramic, glass-ceramic, silicon, or metal. As described above for the first sheet 10, when made of glass, thin sheet 20 may be of any suitable composition, including alumino-silicate, boro-silicate, alumino-boro-silicate, soda-lime-silicate, and may be either alkali containing or alkali-free depending upon its ultimate application. The coefficient of thermal expansion of the thin sheet can be matched substantially the same with that of the first sheet to reduce any warping of the article during processing at elevated temperatures. The thickness 28 of the thin sheet 20 is about 300 μm or less, as noted above, such as about 200 μm or about 100 μm. Further, the thin sheet may be of a Gen 1 size or larger, for example, Gen 2, Gen 3, Gen 4, Gen 5, Gen 8 or larger (e.g., sheet sizes from about 100 mm×100 mm to about 3 meters×3 meters or greater).

The article 2 can have a thickness that accommodates processing with existing equipment, and likewise it can survive the harsh environment in which the processing takes place. For example, thin film transistor (TFT) processing may be carried out at high temperature (e.g., ≥about 200° C., ≥300° C., ≥400° C., and up to less than 500° C.). For some processes, as noted above, the temperature may be ≥about 200° C., ≥about 250° C., ≥about 300° C., ≥about 350° C., ≥about 400° C., and up to less than 500° C., including any ranges and subranges therebetween.

To survive the harsh environment in which article 2 will be processed, the bonding surface 14 should be bonded to bonding surface 24 with sufficient strength so that the thin sheet 20 does not separate from first sheet 10. This strength should be maintained throughout the processing so that sheet 20 does not separate from sheet 10 during processing. Further, to allow sheet 20 to be removed from sheet 10 (so that a carrier may be reused, for example), the bonding surface 14 should not be bonded to bonding surface 24 too strongly either by the initially designed bonding force, and/or by a bonding force that results from a modification of the initially designed bonding force as may occur, for example, when the article undergoes processing at high temperatures, e.g., temperatures of ≥about 200° C., about 300° C., to ≥about 400° C., and up to less than 500° C. The modification layer 30 may be used to control the strength of bonding between bonding surface 14 and bonding surface 24 so as to achieve both of these objectives. The controlled bonding force is achieved by controlling the contributions of van der Waals (and/or hydrogen bonding) and covalent attractive energies to the total adhesion energy which is controlled by modulating the polar and non-polar surface energy components of sheet 20 and sheet 10. This controlled bonding is strong enough to survive TFT processing, for instance, including temperatures ≥about 200° C., and in some instances, processing temperatures of ≥about 200° C., ≥about 250° C., ≥about 300° C., ≥about 350° C., ≥about 400° C., about 450° C., and up to less than 500° C., and remain debondable by application of a force sufficient to separate the sheets but not cause significant damage to sheet 20 and/or sheet 10. For example, the applied force should not break either sheet 20 or sheet 10. Such debonding permits removal of sheet 20 and the devices fabricated thereon, and also allows for re-use of sheet 10 as a carrier.

Although the modification layer 30 is shown as a solid layer between sheet 20 and sheet 10, such need not be the case. For example, the layer 30 may be on the order of about 0.1 nm to about 1 μm thick (e.g., about 1 nm to about 10 nm, about 10 nm to about 50 nm, about 50 nm to about 100 nm, about 250 nm, about 500 nm to about 1 μm), and may not completely cover the entire portion of the bonding surface 14. For example, the coverage on bonding surface 14 may be ≤about 100%, from about 1% to about 100%, from about 10% to about 100%, from about 20% to about 90%, or from about 50% to about 90% of the bonding surface 14, including any ranges and subranges therebetween. In other embodiments, the layer 30 may be up to about 50 nm thick, or in other embodiments even up to about 100 nm to about 250 nm thick. The modification layer 30 may be considered to be disposed between sheet 10 and sheet 20 even though it may not contact one or the other of sheet 10 and sheet 20. In other embodiments, the modification layer 30 modifies the ability of the bonding surface 14 to bond with bonding surface 24, thereby controlling the strength of the bond between the sheet 10 and sheet 20. The material and thickness of the modification layer 30, as well as the treatment of the bonding surfaces 14, 24 prior to bonding, can be used to control the strength of the bond (energy of adhesion) between sheet 10 and sheet 20.

Deposition of the Modification Layer

Examples of coating methods for providing a modification layer 30 include chemical vapor deposition (CVD) techniques, and like methods. Specific examples of CVD techniques include CVD, low pressure CVD, atmospheric pressure CVD, Plasma Enhanced CVD (PECVD), atmospheric plasma CVD, atomic layer deposition (ALD), plasma ALD, and chemical beam epitaxy.

The reactive gas mixture used to produce the films may also comprise a controlled amount of a source gas (carrier gas) selected from hydrogen and inert gases, for example, He, Ar, Kr, Xe. When using low radio frequency (RF) energy, the source gas may comprise nitrogen. The amount of source gas may be controlled by the type of gas used, or by the film deposition process conditions.

As used herein, the term “polymerized monomer” is a monomer that has been deposited onto a carrier or a thin sheet by plasma polymerization, such as by CVD. In some aspects, the monomer is an aromatic monomer of the following structure:

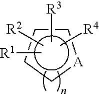

wherein A=C, S or N
n=1 or 2
R¹, R², R³, R⁴ are each independently selected from H, C₁-C₅ alkyl, vinyl, allyl, amino, glycidyl and thiol.

In some embodiments, the polymerized monomer can form a modification layer.

Surface Energy of the Modification Layer

As referred to herein, the surface energy of the modification layer is a measure of the surface energy of the modification layer as it exists on the carrier. In general, the surface energy of the modification layer 30 can be measured upon being deposited and/or further treated, for example by activation with nitrogen or a mixture of nitrogen and oxygen. The surface energy of the solid surface is measured indirectly by measuring the static contact angles of three liquids—water, diiodomethane and hexadecane—individually deposited on the solid surface in air. Surface energies as disclosed herein were determined according to the Wu model, as set forth below. (See: S. Wu, J. Polym. Sci. C, 34, 19, 1971). In the Wu model, the surface energies, including total, polar, and dispersion components, are measured by fitting a theoretical model to three contact angles of three test liquids: water, diiodomethane and hexadecane. From the contact angle values of the three liquids, a regression analysis is done to calculate the polar and dispersion components of the solid surface energy. The theoretical model used to calculate the surface energy values includes the following three independent equations relating the three contact angle values of the three liquids and the dispersion and polar components of surface energies of the solid surface as well as the three test liquids

$$\begin{matrix}{γ}_{W} ( 1 + cos {θ}_{W} ) = 4 ( \frac{{γ}_{W}^{d} {γ}_{S}^{d}}{{γ}_{W}^{d} + {γ}_{S}^{d}} + \frac{{γ}_{W}^{p} {γ}_{S}^{p}}{{γ}_{W}^{p} + {γ}_{S}^{p}} ) & ( 1 ) \\ {γ}_{D} ( 1 + cos {θ}_{D} ) = 4 ( \frac{{γ}_{D}^{d} {γ}_{S}^{d}}{{γ}_{D}^{d} + {γ}_{S }^{d}} + \frac{{γ}_{D}^{p} {γ}_{S}^{p}}{{γ}_{D}^{p} + {γ}_{S}^{p}} ) & ( 2 ) \\ {γ}_{H} ( 1 + cos {θ}_{H} ) = 4 ( \frac{{γ}_{H}^{d} {γ}_{S}^{d}}{{γ}_{H}^{d} + {γ}_{S }^{d}} + \frac{{γ}_{H}^{p} {γ}_{S}^{p}}{{γ}_{H}^{p} + {γ}_{S}^{p}} ) & ( 3 )\end{matrix}$$

where, the subscripts “W”, “D” and “H” represent water, diiodomethane and hexadecane, respectively, and the superscripts “d” and “p” represent the dispersion and polar components of surface energies, respectively. Since diiodomethane and hexadecane are essentially non-polar liquids, the above set of equations reduces to:

$$\begin{matrix}{γ}_{W} ( 1 + cos {θ}_{W} ) = 4 ( \frac{{γ}_{W}^{d} {γ}_{S}^{d}}{{γ}_{W}^{d} + {γ}_{S}^{d}} + \frac{{γ}_{W}^{p} {γ}_{S}^{p}}{{γ}_{W}^{p} + {γ}_{S}^{p}} ) & ( 4 ) \\ {γ}_{D} ( 1 + cos {θ}_{D} ) = 4 ( \frac{{γ}_{D}^{d} {γ}_{S}^{d}}{{γ}_{D}^{d} + {γ}_{S }^{d}} ) & ( 5 ) \\ {γ}_{H} ( 1 + cos {θ}_{H} ) = 4 ( \frac{{γ}_{H}^{d} {γ}_{S}^{d}}{{γ}_{H}^{d} + {γ}_{S }^{d}} ) & ( 6 )\end{matrix}$$

From the above set of three equations (4-6), the two unknown parameters, dispersion and polar surface energy components of the solid surface, γ_{S}^{d} and γ_{S}^{p} can be calculated by regression analysis. However, with this approach, there is a limiting maximum value up to which the surface energy of the solid surface could be measured. That limiting maximum value is the surface tension of water, which is about 73 mJ/m². If the surface energy of the solid surface is appreciably greater than the surface tension of water, the surface will be fully wetted by water, thereby causing the contact angle to approach zero. Beyond this value of surface energy, therefore, all calculated surface energy values would correspond to about 73-75 mJ/m² regardless of the real surface energy value. For example, if the real surface energies of two solid surfaces are 75 mJ/m² and 150 mJ/m², the calculated values using the liquid contact angles will be about 75 mJ/m² for both surfaces.

Accordingly, all contact angles disclosed herein are measured by placing liquid droplets on the solid surface in air and measuring the angle between the solid surface and the liquid-air interface at the contact line. Therefore, when a claim is made on the surface energy value being from 55 mJ/m² to 75 mJ/m² it should be understood that these values correspond to calculated surface energy values based on the method described above and not the real surface energy values, which could be greater than 75 mJ/m² when the calculated value approaches the real surface energy value.

Bonding Energy of the Second or Thin Sheet to the Modification Layer

As referred to herein, the bond energy of the modification layer is a measure of the force coupling the thin sheet and the carrier. In general, the energy of adhesion (i.e., bond energy) between two surfaces can be measured by a double cantilever beam method or wedge test. The tests simulate in a qualitative manner the forces and effects on an adhesive bond joint at the interface between modification layer 30 and second sheet 20 20. Wedge tests are commonly used for measuring bonding energy. For example, ASTM D5041, Standard Test Method for Fracture Strength in Cleavage of Adhesives in Bonded Joints, and ASTM D3762, Standard Test Method for Adhesive-Bonded Surface Durability of Aluminum, are standard test methods for measuring bonding of substrates with a wedge.

A summary of the test method for determining bond energies as disclosed herein, based on the above-noted ASTM methods, includes recording the temperature and relative humidity under which the testing is conducted, for example, that in a lab room. The second sheet is gently pre-cracked or separated at a corner of the glass article to break the bond between the first sheet and the second sheet. A sharp razor is used to pre-crack the second sheet from the first sheet, for example, a GEM brand razor with a thickness of about 228±20 microns. In forming the pre-crack, momentary sustained pressure may be needed to fatigue the bond. A flat razor having the aluminum tab removed is slowly inserted until the crack front can be observed to propagate such that the crack and separation increases. The flat razor does not need to be inserted significantly to induce a crack. Once a crack is formed, the glass article is permitted to rest for at least 5 minutes to allow the crack to stabilize. Longer rest times may be needed for high humidity environments, for example, above 50% relative humidity.

The glass article with the developed crack is evaluated with a microscope to record the crack length. The crack length is measured from the end separation point of the second sheet from the first sheet (i.e. furthest separation point from the tip of razor) and the closest non-tapered portion of the razor. The crack length is recorded and used in the following equation to calculate bond energy.

γ=3t_{b}²E₁t_{w1}³E₂t_{w2}³/16L⁴(E₁t_{w1}³+E₂t_{w2}³) (7)

wherein γ represents the bond energy, t_{b} represents the thickness of the blade, razor or wedge, E₁ represents the Young's modulus of the first sheet 10 (e.g., a glass carrier), t_{w1} represents the thickness of the first sheet, E₂ represents the Young's modulus of the second sheet 20 (e.g., a thin glass sheet), t_{w2} represents the thickness of the second sheet 20 and L represents the crack length between the first sheet 10 and second sheet 20 upon insertion of the blade, razor or wedge as described above.

The bond energy is understood to behave as in silicon wafer bonding, where an initially hydrogen bonded pair of wafers are heated to convert much or all the silanol-silanol hydrogen bonds to Si—O—Si covalent bonds. While the initial room temperature hydrogen bonding produces bond energies on the order of about 100-200 mJ/m² which allows separation of the bonded surfaces, a fully covalently bonded wafer pair as achieved during processing on the order of about 300 to about 800° C. has an adhesion energy of about 2000 to about 3000 mJ/m², which does not allow separation of the bonded surfaces; instead, the two wafers act as a monolith. On the other hand, if both the surfaces are perfectly coated with a low surface energy material, for example a fluoropolymer, with a thickness large enough to shield the effect of the underlying substrate, the adhesion energy would be that of the coating material and would be very low, leading to low or no adhesion between the bonding surfaces 14, 24. Accordingly, the thin sheet 20 would not be able to be processed on sheet 10 (for example a carrier) without failure of the bond and potential damage to the thin sheet 20. Consider two extreme cases: (a) two standard clean 1 (SC1, as known in the art) cleaned glass surfaces saturated with silanol groups bonded together at room temperature via hydrogen bonding (whereby the adhesion energy is about 100 to about 200 mJ/m²) followed by heating to a temperature that converts the silanol groups to covalent Si—O—Si bonds (whereby the adhesion energy becomes about 2000 to about 3000 mJ/m²). This latter adhesion energy is too high for the pair of glass surfaces to be detachable; and (b) two glass surfaces perfectly coated with a fluoropolymer with low surface adhesion energy (about 12 to about 20 mJ/m² per surface) bonded at room temperature and heated to high temperature. In this latter case (b), not only do the surfaces not bond at low temperature (because the total adhesion energy of about 24 to about 40 mJ/m², when the surfaces are put together, is too low), they do not bond at high temperature either as there are too few polar reacting groups. Between these two extremes, a range of adhesion energies exist, for example between about 50 to about 1000 mJ/m², which can produce the desired degree of controlled bonding. Accordingly, the inventors have found various methods of providing a modification layer 30 leading to a bonding energy between these two extremes, and such that there can be produced a controlled bonding sufficient to maintain a pair of substrates (for example a glass carrier or sheet 10 and a thin glass sheet 20) bonded to one another through the rigors of TFT processing but also of a degree that (even after high temperature processing of, e.g. ≥about 200° C., ≥about 300° C., ≥about 400° C., and up to less than 500° C.) allows the detachment of sheet 20 from sheet 10 after processing is complete. Moreover, the detachment of the sheet 20 from sheet 10 can be performed by mechanical forces, and in such a manner that there is no significant damage to at least sheet 20, and preferably also so that there is no significant damage to sheet 10.

An appropriate bonding energy can be achieved by using select surface modifiers, i.e., modification layer 30, and/or thermal or nitrogen treatment of the surfaces prior to bonding. The appropriate bonding energy may be attained by the choice of chemical modifiers of either one or both of bonding surface 14 and bonding surface 24, which chemical modifiers control both the van der Waals (and/or hydrogen bonding, as these terms are used interchangeably throughout the specification) adhesion energy as well as the likely covalent bonding adhesion energy resulting from high temperature processing (e.g., on the order of ≥about 200° C., ≥about 300° C., ≥about 400° C., and up to less than 500° C.).

Production of the Article

In order to produce the article, for example a glass article, the modification layer 30 is formed on one of the sheets, preferably the first sheet 10 (for example, a carrier). If desired, the modification layer 30 can be subjected to steps such as surface activation and annealing in order increase the surface energy, decrease outgassing during processing and improve the bonding capabilities of the modification layer 30, as described herein. In order to bond the other sheet, for example thin sheet 20, the other sheet is brought into contact with the modification layer 30. If the modification layer 30 has a high enough surface energy, introducing the other sheet to the modification layer 30 will result in the other sheet being bonded to the modification layer 30 via a self-propagating bond. Self-propagating bonds are advantageous in reducing assembly time and/or cost. However, if a self-propagating bond does not result, the other sheet can be bonded to the modification layer 30 using additional techniques, such as lamination, for example by pressing the sheets together with rollers, or by other techniques, as known in the lamination art for bringing two pieces of material together for bonding.

It has been found that an article including a first sheet 10 and a second sheet 20 (for example a carrier and a thin sheet), suitable for TFT processing (including processing at temperatures of about 300° C., 400° C., and up to less than 500° C.), can be made by coating the first sheet 10 and or second sheet 20 with an aromatic organic monomer, for example, a monomer of the following structure:

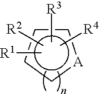

wherein A=C, S or N
n=1 or 2
R¹, R², R³, R⁴ are each independently selected from H, C₁-C₅ alkyl, vinyl, allyl, amino, glycidyl, and thiol;
   polymerizing the monomer to form a modification layer; and coupling the thin sheet and the carrier.

The modification layer can be formed from, for example, one or more monomers based on a five- or six-membered aromatic ring that includes any substitution that is suitable for polymerization.

In one example, the modification layer can be formed by the deposition and polymerization of a monomer having a six-membered (n=2) aromatic ring. The six-membered aromatic ring can be optionally substituted with one, two, three, four, or five substituents covalently bonded to one or more of the ring carbons. The substituents can be independently selected from H, C₁-C₅ alkyl, vinyl, allyl, amino, glycidyl, and thiol. Each substituent can be further substituted, unsubstituted, protected, or unprotected. Where a C₁-C₅, C₁-C₄, C₁-C₃, or C₁-C₂ alkyl substituent is selected, the substituent may be branched or unbranched, saturated or unsaturated. Examples of alkyl groups include methyl, ethyl, n-propyl, iso-propyl, n-butyl, iso-butyl, tert-butyl, n-hexyl, n-decyl, tetradecyl, and the like. In one example, the monomer can be a xylene, such as p-xylene. In another example, the monomer can be substituted with at least two or at least three alkyl groups. The alkyl groups can be different or the same as each other, for instance, di-methyl or tri-methyl.

In another example, the modification layer 30 can be formed by deposition and polymerization of a five-membered (n=1) aromatic ring including a sulfur or a nitrogen at one ring position. The five-membered aromatic ring can further include one, two, three, or four substituents covalently bonded to one or more of the ring carbons, and can be independently selected from H, C₁-C₅ alkyl, vinyl, allyl, amino, glycidyl, and thiol. Each substituent can be further substituted, unsubstituted, protected, or unprotected. Where a C₁-C₅, C₁-C₄, C₁-C₃, or C₁-C₂ alkyl substituent is selected, the substituent may be branched or unbranched, saturated or unsaturated. Examples of alkyl groups include methyl, ethyl, n-propyl, iso-propyl, n-butyl, iso-butyl, tert-butyl, n-hexyl, n-decyl, tetradecyl, and the like. In one example, the monomer can be a thiophene, for example, alkyl thiophenes. Alkyl thiophene can include, for instance, methyl thiophene or dimethyl thiophene. In another example, the monomer is a thiophene that can be substituted with at least two or at least three alkyl groups. The alkyl groups can be different or the same as each other, for instance, di-methyl or tri-methyl.

The modification layer 30 can provide a bonding surface with a surface energy in a range of from about 40 to about 70 mJ/m², as measured for one surface (including polar and dispersion components), whereby the surface produces only weak bonding. The desired surface energy required for bonding may not be the surface energy of the initially deposited aromatic modification layer. In order to increase the surface energy when desired, the deposited layer may be further treated. As initially deposited, and without further processing, the modification layer can show good thermal stability. For example, deposition and polymerization of p-xylene provides a modification layer with a surface energy of about 43 mJ/m², a typical surface energy for a polar organic polymer. Similarly, the deposition and polymerization of methyl thiophene and dimethyl thiophene provides modification layers with surface energies of about 51 mJ/m² and about 41 mJ/m², respectively, without further treatment.

Because these surface energies may be low to promote temporary bonding to bare glass, which has a surface energy in the range of about 75 mJ/m², surface activation of the modification layer may be required to promote glass bonding. Surface energy of the deposited aromatic layers can be raised to about 70 mJ/m² by plasma exposure to N₂, N₂—H₂, N₂—O₂, NH₃, N₂H₄, HN₃, CO₂, or mixtures thereof.

In an example, a p-xylene layer can be deposited under a low pressure plasma discharge from a p-xylene precursor with a hydrogen carrier gas in a Plasma-Treat PTS 150 CVD apparatus (available from Plasmatreat USA Inc. Belmont Calif.) under the following process conditions: a reactor wall temperature of about 50° C. with 0.2 millilitres per minute (mL/min) p-xylene injected into the chamber, and 40 standard cubic centimeters per minute (sccm) H₂ added to the gas manifold, resulting in a pressure of about 50 mTorr chamber pressure at deposition. The samples are placed on glass shelves suspended between two RF powered electrodes with, 25-50 watts (W), and 13.56 MHz RF energy applied. Deposition temperature was achieved in a vaporizer, but adjustments to the deposition temperature can also be made via oven, vacuum chamber, etc.

During surface activation, N—C, N═C and/or NH₂ can be introduced with N₂ and/or N₂—O₂ surface activation of modification layer 30. For example, more than 60% of the nitrogen from N₂ can be introduced to the modification layer surface as an amine. These polar surface groups may be responsible for plasma activation of the modification layer surface, thereby raising the surface energy of the aromatic modification layer, e.g., p-xylene, to nearly that of glass (i.e. greater than about 66 mJ/m²) and thus allowing bonding with a thin glass sheet.

Table 1 shows the surface energy of an approximately 80 nm thick p-xylene plasma polymer film deposited at about 50° C. as measured by contact angle with deionized (DI) water, hexadecane (HD) and diiodomethane (DIM) and interpreted by the Wu method as described above. The surface energy of the p-xylene polymer as deposited was about 43 mJ/m². Both N₂ and N₂—O₂ plasma treatment in an Oxford Plasmalab 100 (available from Oxford Instruments, Oxfordshire UK) raised the surface energy of the p-xylene polymer to over 66 mJ/m². The plasma treatment consists of two sequential steps. Specifically, treatment with a hydrogen plasma (30 seconds (“s”), 10 sccm flow of C₂H₄, 50 sccm flow of H₂, a chamber pressure of 5 mT, the samples were placed on glass shelves suspended between two RF powered electrodes with 1500 W coil, 50 W RF bias) is immediately followed by either an N₂ plasma treatment (5 mT chamber pressure, 25° C. chamber temperature, 40 sccm flow of N₂, 1500 W coil, 50 W bias, for 5 seconds), or by an N₂—O₂ plasma treatment (35 sccm flow of N₂, 5 sccm flow of O₂, 15 mT chamber pressure, 800 W coil, 50 W RF bias, for 5 s) without extinguishing the plasma. This energy (after either N₂ or N₂—O₂ plasma treatment) is high enough that a clean thin glass sheet bonds to the carrier, via the modification layer, with a self-propagating bond.

TABLE 1

| | DI | | | Dis- | Polar | Total |
|---|---|---|---|---|---|---|
| | water | HD | DIM | persive | E | SE |
| As deposited | 87.57 | 2.23 | 8.53 | 37.21 | 5.86 | 43.07 |
| N₂ treatment | 35.23 | 4.03 | 18.27 | 36.4 | 31.41 | 67.81 |
| N₂—O₂ | 37.63 | 3.5 | 16 | 30.16 | 30.16 | 66.8 |
| treatment | | | | | | |

In another example, a methyl thiophene layer can be deposited under a low pressure plasma discharge in a Plasma-Treat PTS 150 CVD apparatus under the following process conditions: a temperature of 180° C. with 0.2 mL/min methyl thiophene and 40 sccm H₂, a pressure of 60 mTorr, 25-50 W, and 13.56 MHz RF energy.

Table 2 shows the surface energy of an approximately 25 nm thick methyl thiophene plasma polymer film deposited at 180° C. as measured by contact angle with DI water, HD and DIM and interpreted by the Wu method as described above. The surface energy of the methyl thiophene polymer as deposited was about 51 mJ/m². Both N₂ and N₂—O₂ plasma treatment in an Oxford Plasmalab 100 (as described in connection with the examples of Table 1) raised the surface energy of the p-xylene polymer to over 62 mJ/m². The energy following N₂—O₂ treatment is high enough that a clean thin glass sheet bonds to the carrier, via the modification layer, with a self-propagating bond.

TABLE 2

| | DI | | | Dis- | Polar | Total |
|---|---|---|---|---|---|---|
| | water | HD | DIM | persive | E | SE |
| As deposited | 65.9 | 4.87 | 26.05 | 35.4 | 15.94 | 51.34 |
| N₂ treatment | 42.8 | 14.1 | 31.9 | 34.01 | 28.47 | 62.48 |
| N₂—O₂ | 36.33 | 14.9 | 24.3 | 35.08 | 31.38 | 66.46 |
| treatment | | | | | | |

In another example, a dimethyl thiophene layer can be deposited under a low pressure plasma discharge in a Plasma-Treat PTS 150 CVD apparatus under the following process conditions: a temperature of 180° C. with 0.2 mL/min methyl thiophene and 40 sccm H₂, a pressure of 60 mTorr, 25-50 W, and 13.56 MHz RF energy.

Table 3 shows the surface energy of an approximately 32 nm thick dimethyl thiophene plasma polymer film deposited at 180° C. as measured by contact angle with DI water, HD and DIM and interpreted by the Wu method as described above. The surface energy of the methyl thiophene polymer as deposited was about 42 mJ/m². Both N₂ and N₂—O₂ plasma treatment in an Oxford Plasmalab 100 (as described in connection with the examples of Table 1) raised the surface energy of the p-xylene polymer to over 62 mJ/m². The energy following N₂—O₂ treatment is high enough that a clean thin glass sheet bonds to the carrier, via the modification layer, with a self-propagating bond.

TABLE 3

| | DI | | | Dis- | Polar | Total |
|---|---|---|---|---|---|---|
| | water | HD | DIM | persive | E | SE |
| As deposited | 73.93 | 3.57 | 0 | 27.55 | 14.16 | 41.71 |
| N₂ treatment | 42.4 | 14.6 | 27.53 | 34.64 | 28.45 | 63.09 |
| N₂—O₂ | 37 | 13.3 | 26.67 | 34.88 | 31.11 | 65.99 |
| treatment | | | | | | |

It is believed that other aromatic precursors comprising five and six-membered aromatic rings, for example R¹, R² are each independently selected from H, C₁-C₅ alkyl, vinyl, allyl, amino, glycidyl and thiol, would produce similar results as shown and described herein.

The use of a surface modification layer 30, together with bonding surface preparation as appropriate, can achieve a controlled bonding area, that is a bonding area capable of providing a room-temperature bond between sheet 20 and sheet 10 sufficient to allow the article 2 to be processed in TFT type processes, and yet a bonding area that controls covalent bonding between sheet 20 and sheet 10 (even at elevated temperatures) so as to allow the sheet 20 to be removed from sheet 10 (without damage to the sheets) after high temperature processing of the article 2, for example, processing at temperatures of ≥about 300° C., ≥about 400° C., and up to less than 500° C. To evaluate potential bonding surface preparations, and modification layers with various bonding energies, that would provide a reusable carrier suitable for TFT processing, a series of tests were used to evaluate the suitability of each. Different applications have different requirements, but LTPS and Oxide TFT processes appear to be the most stringent at this time. Thus, tests representative of steps in these processes were chosen, as these are desired applications for the article 2. Annealing at about 400° C. is used in oxide TFT processes. Accordingly, the following testing was carried out to evaluate the likelihood that a particular bonding surface preparation and modification layer would allow a thin sheet to remain bonded to a carrier throughout TFT processing, while allowing the thin sheet to be removed from the carrier (without damaging the thin sheet and/or the carrier) after such processing (including processing at temperatures ≥about 200° C., about 300° C., about 400° C., up to less than 500° C.).

Thermal Testing of Bond Energy

The bonding energy of the modification layers to thin sheets, e.g., thin glass sheets, was tested after specific heating conditions. To see whether a particular surface modification layer would allow a thin sheet to remain bonded to a carrier and still allow the thin sheet to be debonded from the carrier after processing, the following test was carried out. The article (thin sheet bonded to the carrier via the surface modification layer) was put in a furnace that ramped to the desired processing-test temperature at a rate of 4° C. per second. The article was then held in the furnace (maintained at the desired processing-test temperature) for 10 minutes. The furnace was then cooled to about 150° C. within 45 minutes, and the sample was pulled. The article was then tested for bond energy according to the Bond Energy test set forth herein.

Surface modification layers can be used to couple a thin sheet to a carrier at room temperature. For example, after surface activation, thin glass can bond very well to xylenes (e.g., p-xylene) and thiophenes (e.g., methyl thiophene, dimethyl thiophene) modification layer bonding surfaces with a very high bond speed consistent with the high surface energy. As used herein, a modification layer bonding surface is the surface of the modification layer that will be in contact with the coupled sheet, that is, the thin sheet, following coupling.

After room temperature bonding, the article is then thermally tested to see how the bond energy will increase after thermal processing by using the above-described thermal testing of bond energy. The bond energy of thin glass bonded with nitrogen- or a mixture of nitrogen-and-oxygen-treated aromatic modification layers can rise to about 150 to about 450 mJ/m² and remain near that value after processing the article at a temperature of about 200° C., about 250° C., about 300° C., about 350° C., about 400° C. or up to less than 500° C. Thus, the aromatic surface modification layers can consistently maintain a bond energy less than about 450 mJ/m², about 400 mJ/m², about 375 mJ/m², about 350 mJ/m², about 325 mJ/m², or about 300 mJ/m² with the thin glass sheet even after processing at about 200° C., about 250° C., about 300° C., about 350° C., about 400° C. or up to less than 500° C., e.g., upon holding the glass article in an inert atmosphere that is at about 200° C., about 250° C., about 300° C., about 350° C., about 400° C. or less than 500° C. for about 10 minutes, according to the thermal testing of bond energy. In another example, the bond energy of thin sheets bonded with nitrogen- or a mixture of nitrogen-and-oxygen-treated aromatic modification layers can be consistently maintained in the range of about 100 to about 450 mJ/m², about 100 to about 400 mJ/m², about 100 to about 350 mJ/m², or about 100 to about 300 mJ/m² after processing the glass article in an inert atmosphere that is at a temperature in the range of from 200 to 400° C., and up to less than 500° C., for 10 minutes according to the thermal testing of bond energy.

Outgassing of the Modification Layer

Polymer adhesives used in typical wafer bonding applications are generally about 10 to about 100 μm thick and lose about 5% of their mass at or near their temperature limit. For such materials, evolved from thick polymer films, it is easy to quantify the amount of mass loss, or outgassing, by mass-spectrometry. On the other hand, it is more challenging to measure the outgassing from thin surface treatments that are on the order of about 10 to about 100 nm thick or less, for example the plasma polymer or self-assembled monolayer surface modification layers described above, as well as for a thin layer of pyrolyzed silicone oil. For such materials, mass-spectrometry is not sensitive enough. There are a number of other ways to measure outgassing, however.

In an example test, hereinafter “OUTGAS SING TEST”, measuring small amounts of outgassing can be based on an assembled article, e.g., one in which a thin sheet is bonded to a carrier via an aromatic modification layer, and uses a change in percent blister area to determine outgassing. The OUTGAS SING TEST described below was used to measure change in percent blister areas as discussed herein. During heating of the glass article, blisters formed between the carrier and the thin sheet indicates outgassing of the modification layer. Outgassing results from vaporization of small molecules in the coating as well as thermal decomposition of the coating. Outgassing under the thin sheet may be limited by strong adhesion between the thin sheet and carrier. Nonetheless, layers ≤about 10 nm thick may still create blisters during thermal treatment, despite their smaller absolute mass loss. And the creation of blisters between the thin sheet and carrier may cause problems with pattern generation, photolithography processing, and/or alignment during device processing onto the thin sheet. Additionally, blistering at the boundary of the bonded area between the thin sheet and the carrier may cause problems with process fluids from one process contaminating a downstream process. A change in % blister area of ≥about 5 is significant, indicative of outgassing, and is not desirable. On the other hand a change in % blister area of ≤about 1 is insignificant and an indication that there has been no outgassing.

The average blister area of bonded thin glass in a class 1000 clean room with manual bonding is about 1%. The blister percent in bonded carriers is a function of cleanliness of the carrier, thin glass sheet, and surface preparation. Because these initial defects act as nucleation sites for blister growth after heat treatment, any change in blister area upon heat treatment less than about 1% is within the variability of sample preparation. To carry out this outgassing test, a commercially available desktop scanner with a transparency unit (Epson Expression 10000XL Photo) is used to make a first scan image of the area bonding the thin sheet and carrier immediately after bonding. The parts are scanned using the standard Epson software using 508 dpi (50 micron/pixel) and 24 bit RGB. The image processing software first prepares an image by stitching together, as necessary, images of different sections of a sample into a single image and removing scanner artifacts (by using a calibration reference scan performed without a sample in the scanner). The bonded area is then analyzed using standard image processing techniques such as thresholding, hole filling, erosion/dilation, and blob analysis. The Epson Expression 11000XL Photo may also be used in a similar manner. In transmission mode, blisters in the bonding area are visible in the scanned image and a value for blister area can be determined. Then, the blister area is compared to the total bonding area (i.e., the total overlap area between the thin sheet and the carrier) to calculate a percent area of the blisters in the bonding area relative to the total bonding area. The samples are then heat treated in a MPT-RTP600s Rapid Thermal Processing system under an N₂ atmosphere at test-limit temperatures of about 200° C., about 250° C., about 300° C., about 400° C. and about 500° C., for 10 minutes. Specifically, the time-temperature cycle used includes: inserting the article into the heating chamber at room temperature and atmospheric pressure; heating the chamber to the test-limit temperature at a rate of 9° C. per minute; holding the chamber at the test-limit temperature for about 10 minutes; cooling the chamber at furnace rate to 200° C.; removing the article from the chamber and allow the article to cool to room temperature; and scanning the article a second time with the optical scanner. The percent blister area from the second scan can be then calculated as above and compared with the percent blister area from the first scan to determine a change in percent blister area. As noted above, a change in blister area equal to or greater than 5% is significant and an indication of outgassing. A change in percent blister area was selected as the measurement criterion because of the variability in original percent blister area. That is, most surface modification layers have a blister area of about 2% in the first scan due to handling and cleanliness after the thin sheet and carrier have been prepared and before they are bonded. However, variations may occur between materials.

The percent blister area being measured, as exemplified by the change in percent blister area, can also be characterized as the percent of total surface area of the modification layer bonding surface not in contact with the second sheet 20 bonding surface 24. As described above, the percent of total surface area of the modification layer bonding surface not in contact with the second sheet is desirably less than about 10%, less than about 8%, less than about 5%, less than about 3%, less than about 1% and up to less than about 0.5% after the glass article is subjected to a temperature cycle by heating in a chamber cycled from room temperature to about 200° C., about 250° C., about 300° C., about 400° C. and up to less than about 500° C. at a rate in the range of from about 200° C. to about 600° C. per minute and then held at the test temperature for 10 minutes before allowing the glass article to cool to room temperature. The modification layer described herein allows the second sheet to be separated from the first sheet without breaking the second sheet into two or more pieces after the glass article is subjected to the above temperature cycling and thermal testing.

### EXAMPLES

### Example 1

A p-xylene modification layer was deposited on a carrier (made from Corning® EAGLE XG® alkali-free display glass having a thickness of about 0.7 mm) under a low pressure plasma discharge in a Plasma-Treat PTS 150 system at a chamber temperature of 50° C., a chamber pressure of 50 mT from 0.2 mL/min p-xylene, 40 sccm H₂ flow, and 25-50 W bias with 13.56 MHz RF. In this system, RF drives a pair of electrodes in the chamber and the substrates sit at floating potential in the discharge between the electrodes. Table 1 (above) shows the surface energy of an approximately 80 nm thick p-xylene plasma polymer film, deposited at 50° C., measured as described.

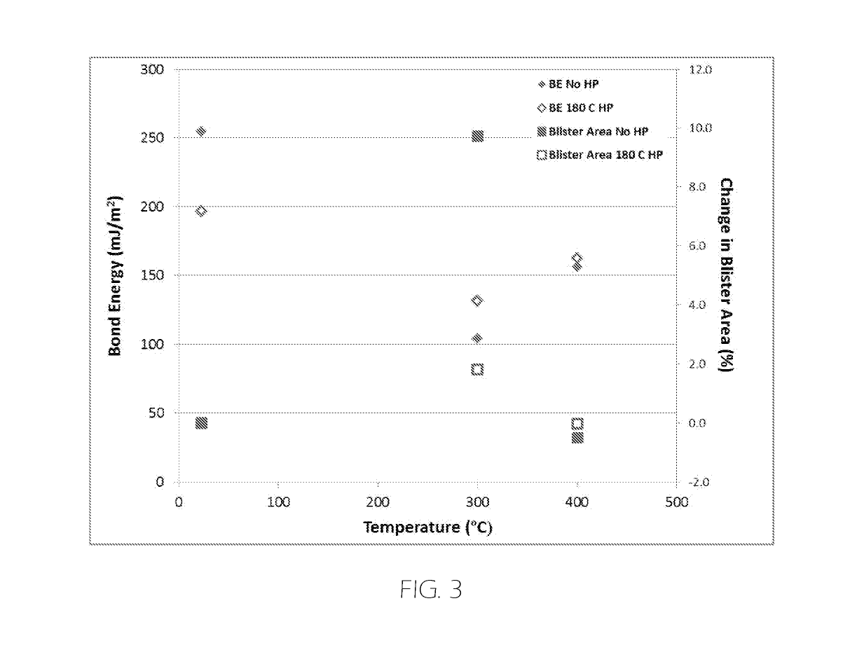

FIG. 3 shows the bond energy (left-hand Y-axis, filled and open diamond data points) and outgassing (right-hand Y-axis, filled and open square data points) of a glass article including an approximately 80 nm thick p-xylene modification layer deposited at 50° C., and having a thin glass sheet (thickness of 100 microns) coupled to the carrier via the modification layer. The thin glass sheet was Corning® Willow® glass (an alkali-free glass suitable for displays). As deposited, the p-xylene film produced a bond energy between the thin glass sheet and the carrier of about 250 mJ/m² at room temperature, of about 100 mJ/m² after testing the article at 300° C., and of about 155 mJ/m² after testing the article at 400° C. See the filled diamond data points and runs 1-3 in Table 4 below. As deposited, the p-xylene films exhibited a change in blister area of about 10% after testing at 300° C., which is consistent with outgassing according to the outgassing test. See the filled square data points and run 2 in Table 4 below. In run 3 of Table 4, the p-xylene films as deposited exhibited almost no change in blister area, which facially is consistent with no outgassing. However, due to the outgassing of the same films at the lower test temperature of 300° C., this seems to be an anomaly. Indeed, without wishing to be bound by theory, it is possible that the increased bond energy during the 400° C. test limited the measured bubble formation.

TABLE 4

| Run | Hot Plate (° C.) | RTP | BE (avg, mJ/m²) | Δ area (%) |
|---|---|---|---|---|
| 1 | 50 | 23 | 254.76 | 0.0 |
| 1a | 180 | 23 | 196.64 | 0.0 |
| 2 | 50 | 300 | 104.20 | 9.7 |
| 2a | 180 | 300 | 131.31 | 1.8 |
| 3 | 50 | 400 | 155.91 | −0.5 |
| 3a | 180 | 400 | 162.50 | 0.0 |

To address blistering and loss of bond energy, an annealing step can be added to the processing if needed. Following deposition of the polymer on the carrier, and before coupling with the thin sheet, the polymerized modification layer can be heat treated (annealed) using a hot plate, oven, etc., to improve bonding and/or outgassing properties. Alternatively, it is quite possible that the polymer deposition temperature can be increased to achieve the same reduced outgassing effect by encouraging low molecular weight and/or partially polymerized species to evaporate from the carrier during the deposition itself, rather than by a post-deposition heat treatment. Thermal or plasma annealing of the plasma polymer after deposition may be accomplished in both batch and inline tools, and may be used to remove partially polymerized material from the coatings. This can significantly decrease outgassing.

In the current example, for the heat treatment (anneal) step, the plasma polymer modification layer (as existing on the carrier after deposition) was heated in a nitrogen gas atmosphere at a temperature of 180° C. for 10 minutes on a hot plate, after which the thin glass was coupled to the carrier via the modification layer. In this example, as shown in FIG. 3, the bond energy between the carrier and the thin sheet was about 200 mJ/m² at room temperature, about 130 mJ/m² after testing in a nitrogen atmosphere at 300° C. for 10 minutes, and about 155 mJ/m² after testing in a nitrogen atmosphere at 400° C. for 10 minutes (see runs 1a, 2a, 3a, in Table 4 above); all acceptable bond energies for allowing the thin glass sheet to be easily debonded from the carrier. See the open diamond data points. By using an annealing step to treat the modification layer, the thin glass remained firmly attached to the carrier with little blistering, even when testing at temperatures up to 400° C. (i.e., the change in blister area was about 2% or less, see the open square data points, and consistent with no/low outgassing).

Accordingly, as shown by the above, p-xylene is a suitable surface modification layer that can be used when processing thin glass sheets on carriers up to temperatures of about 400° C. Such processing temperatures are useful for making display devices including color filters, a-Si TFTs, and/or oxide TFTs.

### Example 2

A methyl thiophene modification layer was deposited on a carrier (made from Corning® EAGLE XG® alkali-free display glass) under a low pressure plasma discharge in a Plasma-Treat PTS 150 system at 180° C., 60 mT from 0.2 mL/min methyl thiophene, 40 sccm H₂ flow, and 25-50 W, 13.56 MHz RF. Table 2 (above) shows the surface energy of ˜25 nm thick methyl thiophene plasma polymer film, deposited at 180° C., using the same conditions as described in connection with Example 1 and the examples of Table 1. Specifically, the methyl thiophene plasma polymer was as deposited, and as activated by each an N₂, and an N₂—O₂ plasma as described above in connection with the examples of Table 1.

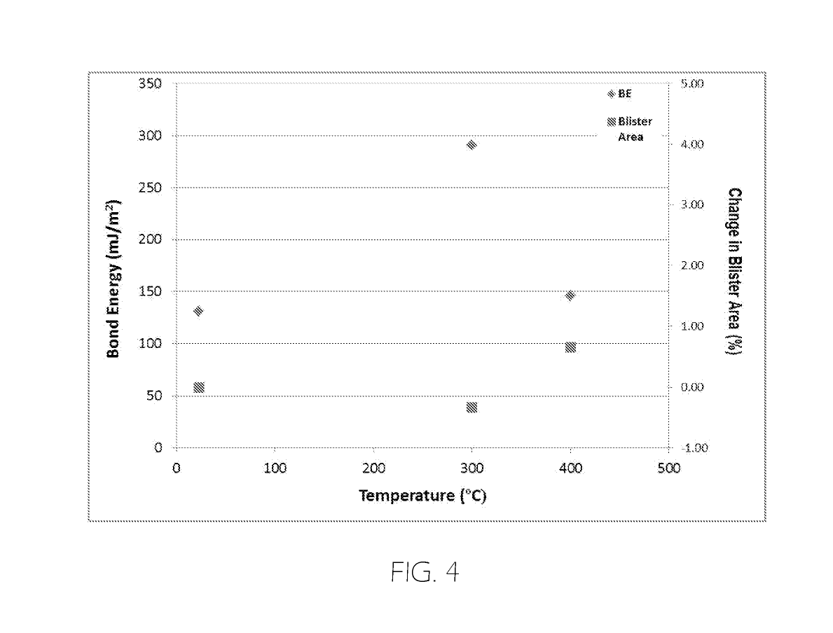

FIG. 4 shows the bond energy (left-hand Y-axis, diamond data points) and outgassing (right-hand Y-axis, square data points) of a glass article including an approximately 25 nm thick methyl thiophene modification layer deposited at 180° C. As deposited, the methyl thiophene film produced a bond energy between the thin glass sheet and the carrier of about 130 mJ/m² at room temperature, of about 290 mJ/m² after testing the article at 300° C., and of about 150 mJ/m² after testing the article at 400° C. See the diamond data points of FIG. 4 and Table 5 below. The glass remained firmly attached to the carrier up to 400° C. As deposited, the methyl thiophene film exhibited a change in blister area of less than about 1% after testing at both 300° C. and 400° C., consistent with no outgassing. See the square data points of FIG. 4 and see, also Table 5 below.

Accordingly, as shown by the above, methyl thiophene is a suitable surface modification layer that can be used when processing thin glass sheets on carriers up to temperatures of about 400° C. Such processing temperatures are useful for making display devices including color filters, a-Si TFTs, and/or oxide TFTs.

TABLE 5

| RTP | BE (avg, mJ/m²) | Δ area (%) |
|---|---|---|
| 23 | 131.3 | 0.0 |
| 300 | 290.4 | −0.34 |
| 400 | 146.0 | 0.65 |

### Example 3

A dimethyl thiophene modification layer was deposited on a carrier (made from Corning® EAGLE XG® alkali-free display glass) under a low pressure plasma discharge in a Plasma-Treat PTS 150 system at 180° C. chamber temperature, 60 mT chamber pressure from 0.2 mL/min dimethyl thiophene, 40 sccm H₂ flow, and 25-50 W bias with 13.56 MHz RF. Table 3 (above) shows the surface energy of an approximately 32 nm thick dimethyl thiophene plasma polymer film, deposited at 180° C. using the same conditions as described in connection with Example 1 and the examples of Table 1. Specifically, the dimethyl thiophene plasma polymer was as deposited, and as activated by each of an N₂ and an N₂—O₂ plasma as described above in connection with the examples of Table 1.

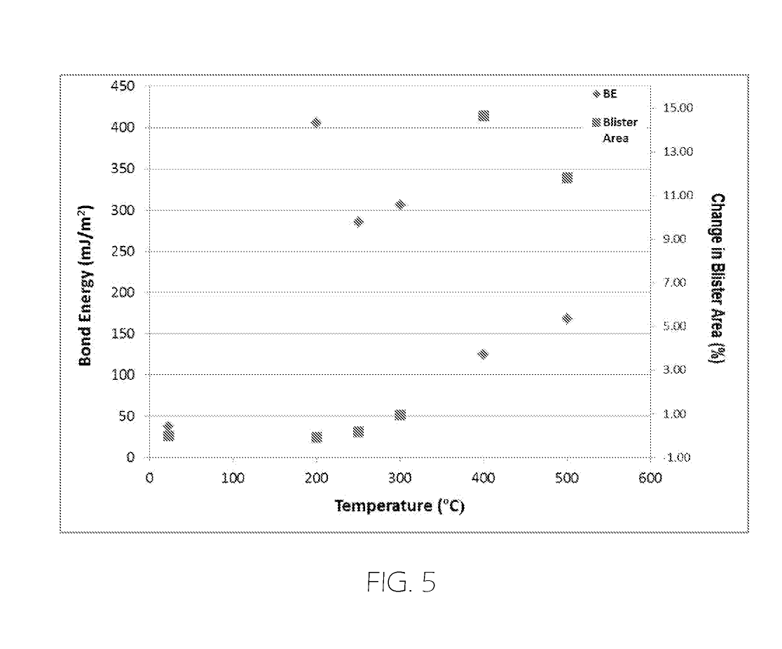

FIG. 5 shows the bond energy (left-hand Y-axis, diamond data points) and outgassing (right-hand Y-axis, square data points) of a glass article including an approximately 32 nm thick dimethyl thiophene modification layer deposited at 180° C. As deposited, the dimethyl thiophene film produced a bond energy, between the thin glass sheet and the carrier, of about 400 mJ/m² at 200° C., of about 290 mJ/m² after testing the article at 250° C., of about 300 mJ/m² after testing the article at 300° C., of about 125 mJ/m² after testing the article at 400° C., and of about 170 mJ/m² after testing the article at 500° C. See the square data points and Table 6 below. The glass remained firmly attached to the carrier up to 300° C. As deposited, the methyl thiophene film exhibited a change in blister area of less than about 2% after testing 200° C., 250° C. and 300° C. See the square data points of FIG. 5 and Table 6 below.

Accordingly, as shown by the above, dimethyl thiophene is a suitable surface modification layer that can be used when processing thin glass sheets on carriers up to temperatures of about 300° C. Such processing temperatures are useful for making display devices including color filters and a-Si TFTs.

TABLE 6

| RTP | BE (avg, mJ/m²) | Δ area (%) |
|---|---|---|
| 23 | 37.7 | 0.0 |
| 200 | 405.6 | −0.08 |
| 250 | 285.3 | 0.17 |
| 300 | 305.7 | 0.96 |
| 400 | 124.7 | 14.64 |
| 500 | 167.8 | 11.80 |

It will be apparent to those skilled in the art that various modifications and variations can be made to the disclosed embodiments without departing from the spirit and scope of the disclosure. Thus, it is intended that the present disclosure cover any and all such modifications and variations as come within the scope of the appended claims and their equivalents.

For example, the modification layers disclosed herein may be used to bond a carrier to a thin sheet, to bond two carriers together, to bond two or more thin sheets together, or to bond a stack having various numbers of thin sheets and carriers together.

1. An article comprising:
a first sheet comprising a first sheet bonding surface;
a second sheet comprising a second sheet bonding surface;
a modification layer comprising a modification layer bonding surface, the modification layer comprising one or more polymerized monomers, wherein the monomer has the following structure: 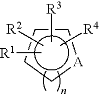
wherein A=C, S or N
n=1 or 2
R¹, R², R³, R⁴ are each independently selected from H, C₁-C₅ alkyl, vinyl, allyl, amino, glycidyl and thiol; and
wherein the modification layer couples the first sheet to the second sheet.

2. The article of claim 1, wherein the monomer is a compound of the formula: 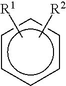
wherein R¹, R² are each independently selected from H, C₁-C₅ alkyl, vinyl, allyl, amino, glycidyl and thiol.

3. The article of claim 2, wherein the monomer isp-xylene.

4. The article of claim 1, wherein the monomer is a compound of the formula: 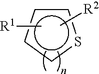
wherein R¹⁻, R² are each independently selected from H, C₁-C₅
alkyl, vinyl, allyl, amino, glycidyl and thiol.

5. The article of claim 1, wherein at least one of the following:
the modification layer bonding surface is bonded with the second sheet bonding surface with a bond energy of less than 325 mJ/m² after holding the glass article at 300° C. for 10 minutes in a nitrogen atmosphere; and
a change in percent blister area of the modification layer is less than 10 percent after holding the glass article at 300° C. for 10 minutes in a nitrogen atmosphere.

6. The article of claim 1, wherein at least one of the following:
the modification layer bonding surface is bonded with the second sheet bonding surface with a bond energy of less than 200 mJ/m² after holding the glass article at 400° C. for 10 minutes in a nitrogen atmosphere; and
a change in percent blister area of the modification layer is less than 5 percent after holding the glass article at 400° C. for 10 minutes in a nitrogen atmosphere.

7. The article of claim 1, wherein an average thickness of the modification layer is less than about 200 nm.

8. The article of claim 1, wherein at least one of the following:
(i) an average thickness of the second sheet is equal to or less than about 300 micrometers;
(ii) an average thickness of the second sheet is less than the average thickness of the first sheet; and
(iii) the average thickness of the first sheet is equal to or greater than about 200 micrometers.

9. A method of making an article comprising:
forming a modification layer on one or more of a bonding surface of a first sheet or a bonding surface of a second sheet by depositing via chemical vapor deposition of at least one monomer of the following formula: 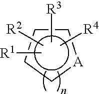
wherein A=C, S or N
n=1 or 2
R¹, R², R³, R⁴ are each independently selected from H, C₁-C₅ alkyl, vinyl, allyl, amino, glycidyl and thiol; the modification layer comprising one or more modification layer bonding surfaces; and
coupling the first sheet and the second sheet with the modification layer.

10. The method of claim 9, wherein the monomer is selected from the group consisting of p-xylene, methyl thiophene and dimethyl thiophene.

11. The method of claim 9, further including the step of increasing the surface energy of the modification layer bonding surface prior to bonding the modification layer bonding surface to the bonding surface of the first or second sheet.

12. The method of claim 11, wherein a surface energy of the modification layer bonding surface is increased by exposing the modification layer bonding surface to nitrogen, oxygen, hydrogen, carbon dioxide gas or a combination thereof.

13. The method of claim 11, comprising increasing the surface energy of the modification layer bonding surface to between 55 and 75 mJ/m².

14. The method of claim 9, wherein an average thickness of the modification layer is less than about 200 nm.

15. The method of claim 9, wherein the modification layer bonding surface is bonded with the second sheet bonding surface with a bond energy less than 325 mJ/m² after holding the glass article at 300° C. for 10 minutes in a nitrogen atmosphere.

16. The method of claim 9, wherein the modification layer bonding surface is bonded with the second sheet bonding surface with a bond energy less than 200 mJ/m² after holding the glass article at 400° C. for 10 minutes in a nitrogen atmosphere.

17. The method of claim 9, wherein at least one of the following:
(i) an average thickness of the second sheet is less than an average thickness of the first sheet;
(ii) an average thickness of the second sheet is equal to or less than about 300 micrometers; and
(iii) an average thickness of the first sheet is equal to or more than about 200 micrometers.
